(19) United States
(12) Patent Application Publication
(10) Pub. No.: US 2004/0233250 A1
(43) Pub. Date: Nov. 25, 2004

(54) Microcontact printhead device

(76) Inventors: Robert C. Haushalter, Los Gatos, CA (US); Srinivas Vetcha, Sunnyvale, CA (US)

Correspondence Address: DUANE MORRIS LLP, 100 COLLEGE ROAD WEST, SUITE 100, PRINCETON, NJ, 08540-6604, US

(21) Appl. No.: 10/795,188

(22) Filed: Mar. 5, 2004

Related U.S. Application Data
(60) Provisional application No. 60/451,952, filed on Mar. 5, 2003.

(51) Int. Cl. B41J 2/14

(52) U.S. Cl. 347/54

(57) ABSTRACT

A microcontact printhead device having a frame and an array of at least two printing elements unitarily formed with the frame. Each of the printing elements may include a printing tip, a printing fluid reservoir associated with the printing tip, and one or more flexible support members that attach the printing tip to the frame. Also, a method of fabricating the microcontact printhead device using micromachining and a method of using the microcontact printhead device for printing an array of spots.

### RELATED APPLICATIONS

This application claims the benefit of U.S. Provisional Application No. 60/451,952 filed Mar. 5, 2003.

### FIELD OF THE INVENTION

The present invention relates to printing devices, and more particularly, to a microcontact printing device for producing microarrays and a method of fabricating the microcontact printing device.

### BACKGROUND OF THE INVENTION

The microarray format for preparing samples of biological materials is the primary method used for monitoring gene expression and several other important biological parameters. In current microarray formats, arrays of approximately 100-200 μm spots of DNA, RNA, proteins or other biological samples are deposited onto a glass substrate using microcontact printing devices including sharpened stainless steel needles or pins. In a typical experiment, between 4 and 64 of the steel pins are dipped into wells of a source plate, which each contain a different DNA sample, and then touched to the substrate to deposit a spot of DNA. The spots are subsequently subjected to a hybridization reaction with probe/target DNA samples to determine the relative amounts of various DNA molecules in the sample.

The stainless steel pins are typically fabricated from 1/16″ stainless steel rod stock with the sharp tip and capillary channel-fluid reservoir spark cut one at a time with EDM (electronic discharge machine). This laborious serial process results in a current sales price of the pins from $175-625/pin. Recent additions of laser cut and electropolished pins are similarly priced.

In addition to cost issues, the current technology used to fabricate microarrays has other weaknesses. Variability exists in the DNA deposits due to poor pin-to-pin uniformity of printing tip geometry and the sample volume deposited, which leads to difficulties in analysis and decreased confidence in results. The range of DNA deposit sizes that can be printed is currently limited by current printing tip designs, however, it would be advantageous to fit more deposits into smaller spacing on the glass surface. The current technology wastes precious DNA samples, because only a percentage of the sample that goes into the printing tip is actually transferred to the glass surface. The chemical resistance of the pins are issues as is the fact that the printing tips tend to wear which leads to variability in deposit characteristics. The printing pressure of the pins is merely controlled by gravity as there is no mechanism for controlling printing pressure. The only way the pins can be filled with a sample is by dipping.

Accordingly, a microcontact printing device is needed that addresses the problems associated with current microcontact printing devices.

### SUMMARY OF INVENTION

An aspect of the present invention is a microcontact printhead device comprising: a frame; and an array of at least two printing elements unitarily formed with the frame. The printing elements may each include a printing tip, a printing fluid reservoir associated with the printing tip, and at least one support member that attaches the printing tip to the frame.

Another aspect of the present invention is a method of fabricating a microcontact printhead device comprising: providing at least one substrate forming an array of at least two printing fluid reservoirs in a first surface of the at least one substrate; and forming an array of printing tips in a second surface of the at least one substrate, the array of fluid dispensing channels communicating with the array of the at least two printing fluid reservoirs. The method may further comprise forming at least one support member at a bottom of each of the reservoirs.

A further aspect of the present invention is a method of printing an array of spots, comprising: providing a microcontact printhead device having a frame and an array of at least two printing elements formed in the frame, the at least two printing elements including a printing tip and a printing fluid reservoir; filling each of the printing fluid reservoirs with one of at least two sample solutions; and touching a surface with the printing tips to deposit quantities of the sample solutions onto the surface, the quantities of the sample solutions forming the array of spots.

### BRIEF DESCRIPTION OF THE DRAWINGS

FIG. 1 is a top plan view of an exemplary embodiment of the microcontact printhead device of the present invention.

FIG. 2A is a perspective view of an exemplary embodiment of one of the printing elements of the microcontact printhead device.

FIG. 2B is a top plan view of the printing element shown in FIG. 2A.

FIG. 2C is a sectional view of the printing element shown in FIGS. 2A and 2B.

FIG. 3 is a sectional view of an exemplary embodiment of a printing tip of the printing element.

FIGS. 4A and 4B are sectional views of a section of the microcontact printhead device showing the operation thereof.

FIGS. 5A-5E are sectional views showing the various stages of an exemplary method for fabricating the microcontact printhead device of the present invention.

FIGS. 6A-6E are sectional views showing the various stages of an another exemplary method for fabricating the microcontact printhead device of the present invention.

FIGS. 7A-7E are sectional views showing the various stages of yet another exemplary method for fabricating the microcontact printhead device of the present invention.

FIG. 8A is a top plan view of another exemplary embodiment of the printing element.

FIG. 8B is an enlarged top plan view of a section of the printing element shown in FIG. 10B.

FIGS. 9A-9E are sectional views showing the various stages of a further exemplary method for fabricating another exemplary embodiment of the microcontact printhead device of the present invention.

FIG. 10 is a sectional view of another exemplary embodiment of the printing element.

FIG. 11 is a top plan view of an additional exemplary embodiment of the microcontact printhead device of the present invention.

FIG. 12A is a top plan view of the printing element shown in FIG. 11.

FIG. 12B is a sectional view of the printing element shown in FIG. 12A embodied with a printing fluid reservoir.

FIG. 12C is a sectional view of the printing element shown in FIG. 12A embodied without a printing fluid reservoir.

### DETAILED DESCRIPTION OF THE INVENTION

An aspect of the present invention is a microcontact printhead device. The microcontact printhead device is especially useful for printing and manufacturing high quality microarrays of proteins, DNA, RNA, polypeptides, oligonucleotides and microarrays of other biological materials having spot volumes in the range of 10⁻¹⁰ picoliters to 100 nanoliters. The microcontact printhead device may also be used for printing and manufacturing high quality microarrays of other matters including, without limitation, solid semiconductor quantum dots or liquid dots containing various functional molecules, such as sensors, organic small molecules, organic polymers, solutions of organic polymers, dyes, inks, adhesives, molten metals, solders, glasses, and ceramic oxides.

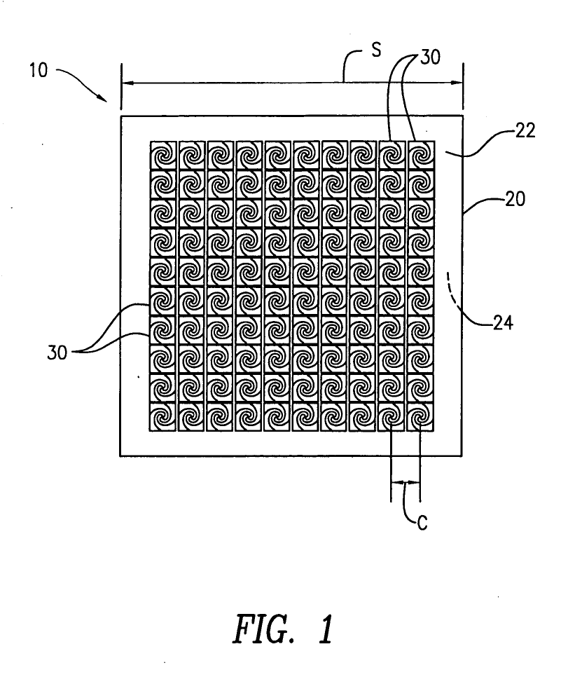

Referring now to the drawings and initially to FIG. 1 there is shown an exemplary embodiment of the microcontact printhead device of the present invention, denoted by reference numeral 10. The microcontact printhead device 10 generally comprises a frame 20 having an upper surface 22 and a bottom surface 24, and an array of printing elements 30 disposed within the frame 20. In the shown embodiment, the microcontact printhead device 10 may comprise a 10×10 array of the printing elements 30 having 2.25 mm center-to-center spacings C. The frame 20 of this printhead device 10 may be configured as a square having 27 mm sides s. The microcontact printhead device 10 may also be constructed in other array sizes, dimensions, and frame configurations. The microcontact printhead device 10 may be composed of any material or combination of materials that are suitable for microfabrication including, without limitation, silicon (Si), silicon oxides (SiO₂), germanium (Ge), germanium-silicon (Ge—Si) alloys, silicon carbide (SiC), silicon nitride (Si₃N₄), polymers, ceramics, and non-ferric alloys. Any suitable microfabrication method or combination of methods may be used for making the microcontact printhead device 10, depending upon the material or materials selected therefor, the desired dimensional precision of the microcontact printhead device 10 and/or the desired manufacturing yield. Suitable microfabrication methods include but are not limited to chemical and physical microfabrication, photolithography, photoresist methods, micro-electromechanical methods, e-beam lithography, and x-ray lithography. Precision machining techniques including, without limitation, EDM and laser cutting may be used to supplement the microfabrication methods. The microcontact printhead device 10 may be micromachined as a single unitary member from a silicon substrate or wafer using conventional photolithographic, wet etching, and Deep Reactive Ion Etching (DRIE) techniques, as will be explained further on. The DRIE process allows the microcontact printhead device 10 to be fabricated with hundreds or thousands of individual printing elements 30. The microcontact printhead device 10 may also be integrally formed from one or more silicon substrates or wafers or a combination of silicon and glass substrates or wafers.

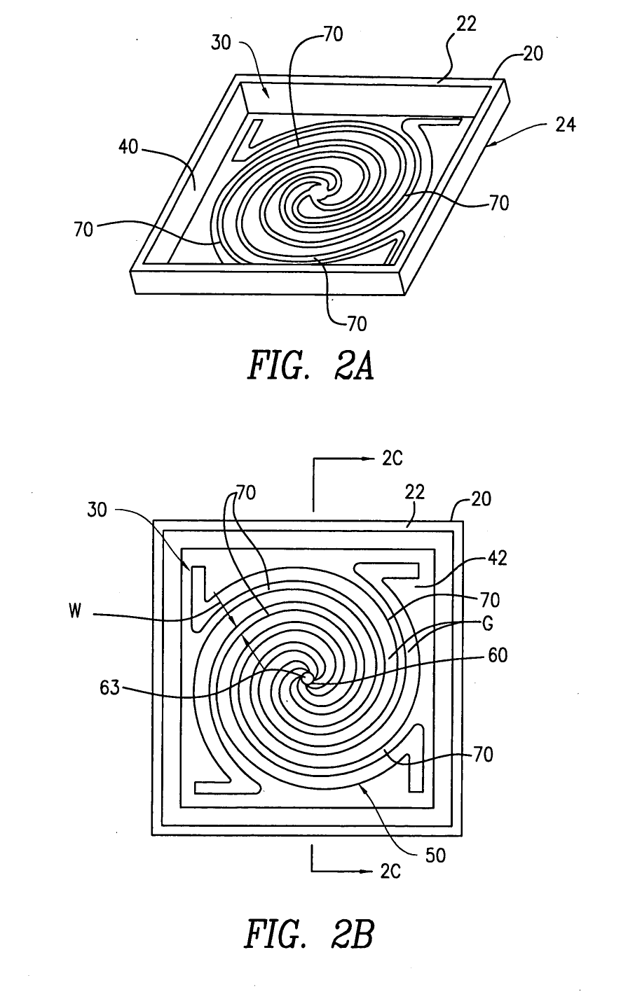

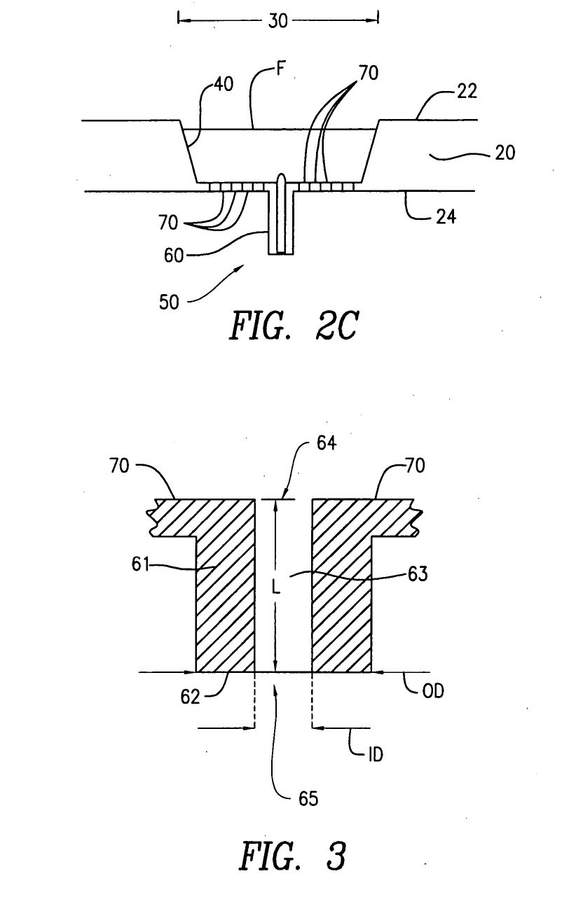

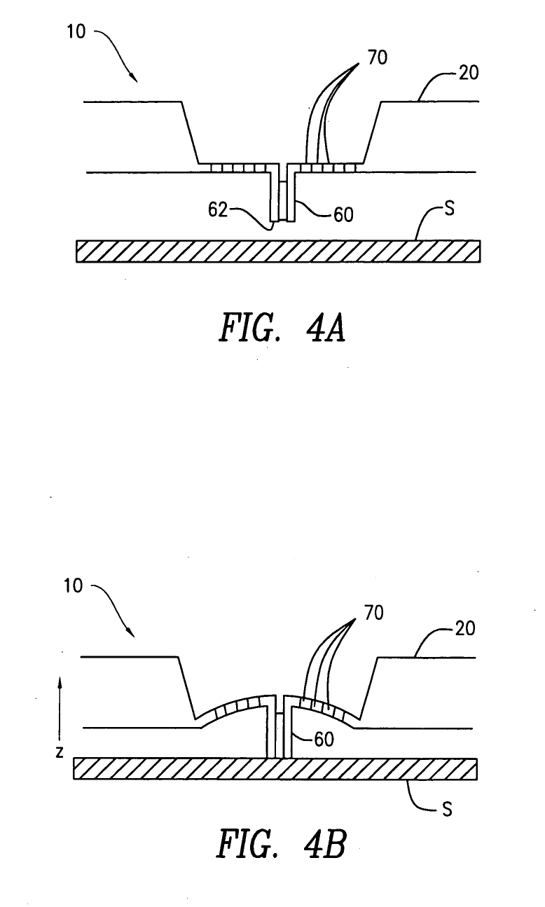

As collectively shown in FIGS. 2A, 2B and 2C, each printing element 30 includes its own, discrete printing fluid reservoir 40 and a printing mechanism 50 disposed at a bottom of the printing fluid reservoir 40, which may include a spring biasing arrangement. Such a printing mechanism 50 may include a printing tip 60 suspended at the bottom of the printing fluid reservoir 40 by one or more spaced apart flexible support members or tethers 70 which attach to a peripheral bottom portion 42 of the reservoir 40 formed by the frame 20 as shown, or directly to the frame 20. The printing tip 60 and the flexible tethers 70 direct a printing fluid F contained in the printing fluid reservoir 40, with capillary forces, into a printing fluid dispensing channel 63 of the printing tip 60 as a printing fluid F contained in the printing fluid reservoir 40 is consumed during the printing process. The printing tip 60 contacts a substrate S (FIGS. 4A and 4B) during printing and dispenses the printing fluid F drawn into the fluid dispensing channel 63 of the printing tip 60 from the printing fluid reservoir 40. The flexible tethers 70 spring bias the printing tip 60 to provide same with the compliance and force needed for successful printing.

The microcontact printhead device 10 is capable of printing an array of spots on a substrate and providing a different printing fluid to each printing tip 60 in the array of printing elements 30 without cross contamination. Unlike conventional microcontact printing devices, the microcontact printhead device 10 of the present invention requires no separate holder for the printing tips because the printing tips 60 are unitary with the flexible tethers 70 which hold the printing tips 60 within the frame 20 of the microcontact printhead device 10. Accordingly, much of the costly precision machining and polishing operations associated with manufacturing conventional microcontact printing devices are eliminated.

Referring to FIG. 3, the printing tip 60, in one exemplary embodiment, may be formed as a small, generally cylindrical tube 61 having an outer diameter OD and a free end surface 62. The earlier described printing fluid dispensing channel 63 of the printing tip 60 has a length L and defines an inner diameter ID of the tube-shape printing tip 60. The fluid dispensing channel 63 communicates with the printing fluid reservoir 40 at a first end 64 thereof and with the end surface 62 at a second end 65 thereof. The free end surface 62 of the printing tip 60 is configured to contact a substrate to be printed on during printing. In the shown embodiment, the end surface 62 may be smooth and flat and oriented generally perpendicular to the fluid dispensing channel 63 of the printing tip 60, such that the end surface 62 is generally parallel to the surface of the substrate. When the end surface 62 of the printing tip 60 contacts the substrate (FIG. 4B), a small amount of the printing fluid is dispensed on the substrate in a manner similar to that of a quill or a fountain pen, i.e., the end surface 62 of the printing tip 60 becomes evenly wetted by the printing fluid F such that the printing tip 60 deposits a uniform spot every time the printing robot in which the microcontact printhead device 10 is mounted goes through a printing cycle.

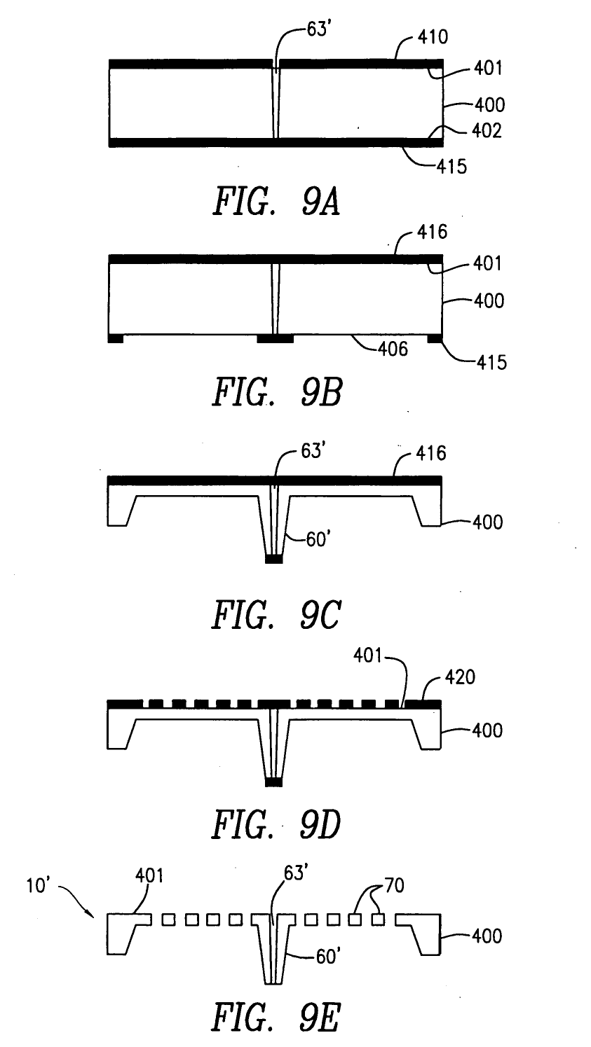

The printing tip 60 may be of any desired size, however, in order to print properly and consume all the printing fluid F in the printing fluid reservoir 40, the aspect ratio of the length L of the fluid dispensing channel 63 and the diameter ID of the fluid dispensing channel 63, must be set so that an effective capillary force draws the printing fluid F into the dispensing channel 63 from the printing fluid reservoir 40. In one exemplary embodiment, assuming the printing fluid F is water, the diameter ID of the fluid dispensing channel 63 may be less than 50 microns (μ), and preferably about 10-20μ, and the corresponding length L of the fluid dispensing channel 63 may be about 10 nanometers (nm)-10.0 millimeters (mm), and preferably about 100-1000 μm in order to maintain printing tip end surface wetness by capillary action. If the diameter ID and length L of the fluid dispensing channel 63, are incorrectly selected, the printing fluid F can retreat back into the printing fluid reservoir 40 upon depletion due to insufficient capillary attraction into the dispensing channel 63 of the printing tip 60. The capillary forces used for directing the printing fluid F into the fluid dispensing channel of the printing tip 60 may be increased by tapering the fluid dispensing channel so that it defines a frustoconically shaped channel 63′ as shown in FIG. 9E.

Printing tips of other configurations are also contemplated. For example, other embodiments of the printing tip may comprise, without limitation, a square, rectangular, oval, or elliptical tube. In addition, the free end surface of the printing tip may also be concave or convex in other embodiments. Such a convex or concave end surface may be smooth or textured. Further, the end surface may be formed by multiple surfaces disposed at various angles to the printing fluid dispensing channel of the printing tip. Referring again to FIGS. 2A, 2B and 2C, the plurality of flexible tethers 70, in one exemplary embodiment, may comprise four, thin, identical, spiral-shape flexible tethers 70 which are equally spaced from one another. The flexible tethers 70 have four functions: (i) to provide the mechanical connection of the printing tip 60 to the frame 20; (ii) to make the porous bottom of the printing fluid reservoir 40 leak proof so that the aqueous printing fluids will not be able to pass between the flexible tethers 70; (iii) to direct the flow of the printing fluid F from the printing fluid reservoir 40 to the fluid dispensing channel 63 of the printing tip 60; and (iv) to prevent any lateral deflection of the printing tip 60 during the printing operation (i.e. allow only motion in the z direction as illustrated in FIG. 4B). It is clear that if the flexible tethers 70 are too thin, the printing tip 60 may sag, have insufficient mechanical stability, possess increased lateral motion when the printing tip 60 contacts the substrate or be subject to low frequency resonant modes. If the flexible tethers 70 are too thick, the printing tip 60 will not be able to deflect over the large required z displacement without breakage. In the earlier-mentioned exemplary embodiment with the 2.25 mm center-to-center printing element spacings C, each of the four tethers 70 may have a thickness in the z direction of about 30μ and a median width W of about 70μ. The requirement for 200μ of deflection in the z direction is a very demanding displacement given the lateral area of the printing element 30. In essence, the spiral shape of the flexible tethers 70 increases their effective length and the stress of the deflection is spread out over the length of the tethers 70. Although most substrates are locally flat to within 2-10μ, variations in z, over the very larger platter (up to about 1 meter²) that delivers the slides under the microcontact printhead device 10 in a typical microarray printing station, can easily be this large.

The flexible tethers 70 are also constructed in a manner that utilizes capillary forces to direct the printing fluid F into the fluid dispensing channel 63 of the printing tip 60 during printing. This may be accomplished by progressively decreasing the gap G between adjacent tethers 70 (and the bottom periphery portion 42 of the reservoir 40 from which the tethers 70 extend) as the tethers 70 extend toward the printing tip 60. This may be accomplished in one embodiment by progressively increasing the width W of the tethers 70 as they extend from the bottom periphery portion 42 of the reservoir 40 toward the printing tip 60. As the printing fluid F is consumed, the narrower portions of the variably changing gaps G retain the printing fluid F longer than the wider portions of the gaps G, and therefore the printing fluid F is drawn toward the printing tip 60 and into the fluid dispensing channel 63 thereof.

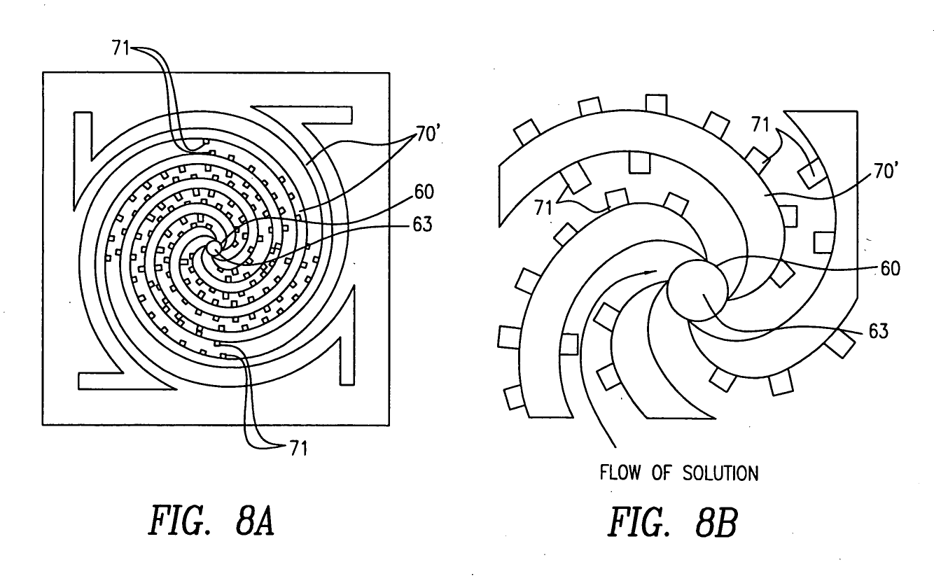

As shown in the alternative embodiment of FIGS. 8A and 8B, the tethers 70′ may also be of a constant width and provided with lateral, interdigital texturing 71. The lateral, interdigital texturing 71 is provided on both sides of each tether 70′ on the portion of the tether 70′ closest to the printing tip 60. Moving further away from the printing tip 60, the lateral, interdigital texturing is provided only on the side of the tether 70′ facing towards the printing tip 60. The portions of the tethers 70′ most remote from the printing tip 60 are not provided with the lateral, interdigital texturing 71.

The increased surface area provided by lateral, interdigital texturing 71 also enables the tethers 70′ to utilize capillary forces to direct the printing fluid F into the fluid dispending channel 63 of the printing tip 60 during printing. The increased surface area provided by the lateral, interdigital texturing 71 also prevents the printing fluid F from flowing through the gaps G between the tethers 70′.

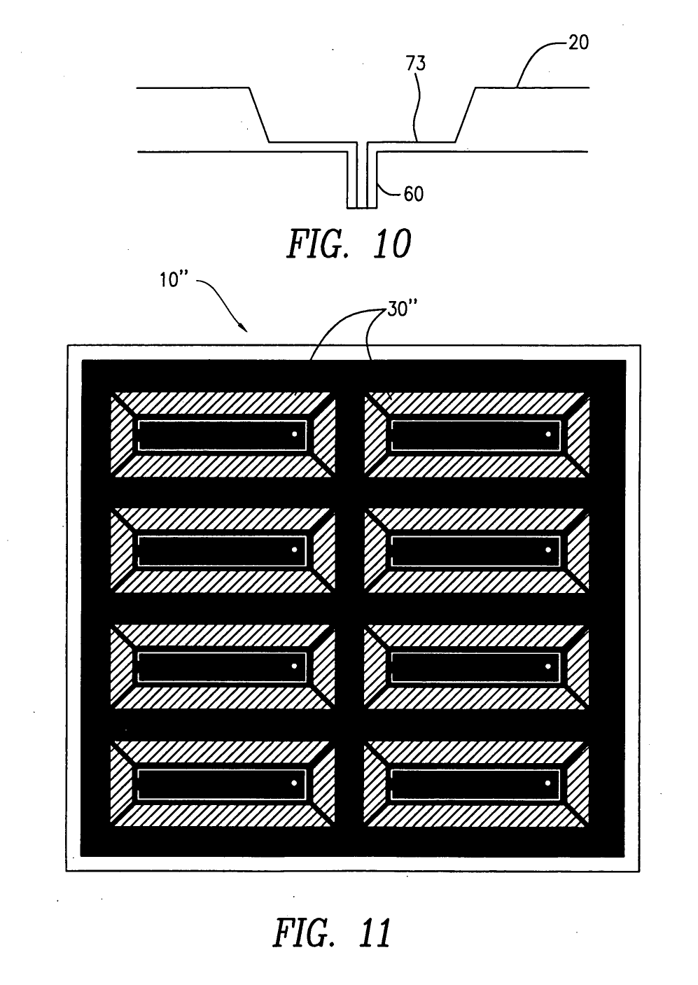

In yet another embodiment, as shown in FIG. 10, the tethers may be replaced by a thin, flexible diaphragm 73 that is unitary with the frame 20.

When the printhead device and therefore, the flexible tethers are fabricated from the preferred silicon material, the printing elements will virtually never fatigue because of the elastic properties of silicon. Unlike metal springs, the printing tips will always return to the same position and deflect with the same amount of force each time during each printing cycle.

The printing fluid reservoirs 40 perform several functions: (i) hold a sufficient quantity of the printing fluid for their corresponding printing tip 60 to print on the order of up to 20,000 spots (or more if desired), preferably without refilling from a source plate; (ii) are designed, via the tethers which form the bottoms thereof, so that all available printing fluid F contained therein to be efficiently consumed as the printing fluid F is depleted therefrom by causing the fluid F to be drawn toward the printing tip 60 and into the dispensing channel 63 thereof; (iii) maintain absolute separation between the printing fluids of adjacent printing elements 30; and (iv) allow thorough cleaning of the entire microcontact printhead device 10. Functions (i) and (ii) are achieved in by using micromachining to fabricate the microcontact-printhead device 10, which allow the individual printing fluid reservoirs 40 to be nearly any arbitrary shape and retention volume, thus enabling the printing fluid reservoirs 40 to be tailored to deliver any volume of printing fluid F. Function (iii) is achieved by separating the printing fluid reservoirs 40 in the frame 20 of the microcontact printhead device 10 and optionally, utilizing a nonwettable coating, such as Teflon® or a chemical surface treatment which renders the appropriate surface regions hydrophobic, e.g., a chemical surface treatment using hexamethyldisilazane, on the inter-reservoir areas of the upper frame surfaces 22 to prohibit any lateral diffusion. Function (iv) is achieved by fabricating the microcontact printhead device 10 from silicon, which can be thoroughly cleaned with procedures such as immersion in boiling nitric acid or treated with steam at 1000° C.

Another aspect of the present invention is a method of fabricating the microcontact printhead device. As mentioned earlier, the microcontact printhead device is preferably fabricated from silicon using silicon micromachining. Silicon micromachining refers to the selective removal of defined regions of silicon or masking material, on the length scales of millimeters to nanometers, from a silicon substrate by an etching process. Etching is the primary means by which the third dimension of a micromachined structure is obtained from a planar photolithographic process. In the case of the microcontact printhead device 10 of the present invention, the printing tip 60, the flexible tethers 70 and the printing fluid reservoir 40 are all three dimensional structures. There are generally two main types of anisotropic etching processes: anisotropic wet etching using hot aqueous KOH and dry/plasma etching techniques such as DRIE. For both etching techniques, the pattern to be etched is defined by a photolithographic process. The substrate from which the microcontact printhead device 10 will be fabricated may be a single crystal silicon wafer, usually with a (100) orientation. The anisotropic wet etching technique involves, after patterned removal of the etch resistant silicon dioxide outer layer, etching at approximately 80° C. in aqueous KOH. Ethylenediamine may also be used as a wet etchant. This chemical etch attacks the silicon <100> planes many times faster than the <111> planes and can be used to etch square pits with approximately 57° <111> sidewalls into (100) silicon wafers. One large advantage of the wet etching technique is that many wafers can be inexpensively etched in parallel but a disadvantage can be the fact that the etch only cuts along certain crystallographic planes and not at arbitrary angles. The most selective dry etching technique is Deep Reactive Ion Etching (DRIE), which is noted for its ability to etch very high aspect ratio trenches. This plasma technique rapidly pulses the etchant and passivator gasses alternatively over the substrate. This etch can cut a thin approximately 10-20μ wide trench through a 500μ thick wafer with sidewalls vertical to within a few degrees over the depth of the cut. The pattern to be etched is simply defined in photoresist, which etches much more slowly than the silicon, and the etch removes the silicon not protected by the etch-resistant photoresist. An advantage of DRIE is that any arbitrary shape can be cut to very high precision but a potential disadvantage is that only one wafer at a time can be processed.

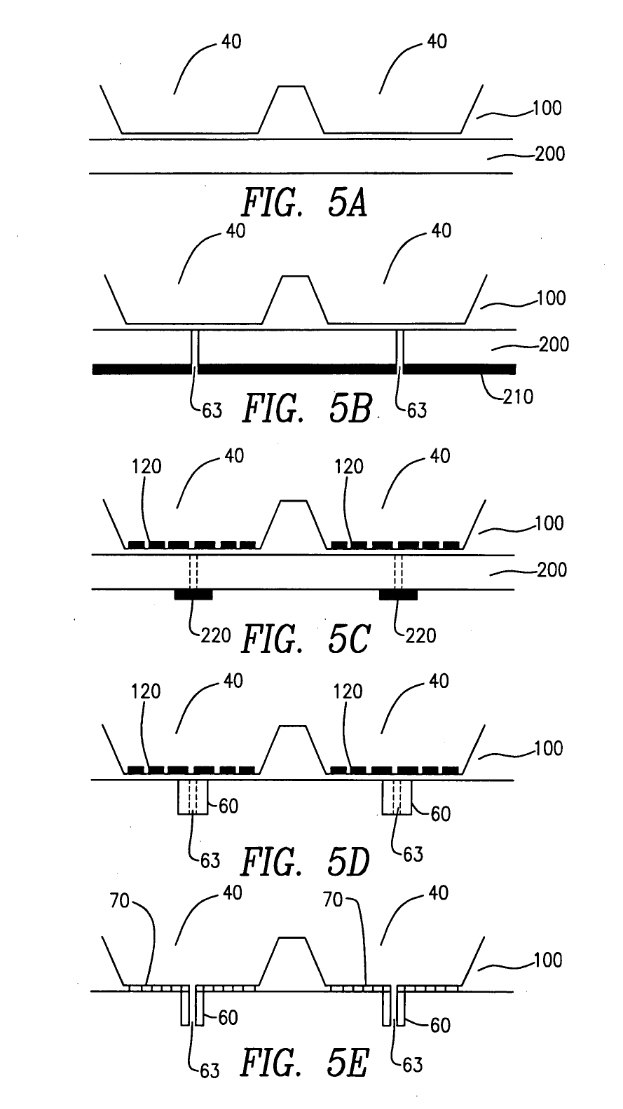

FIGS. 5A-5E collectively show an exemplary embodiment of the microcontact printhead device fabrication method of the present invention. The method commences by bonding two wafers 100, 200 to one another using a conventional bonding techniques such as fusion bonding. Each of the wafers 100, 200 is preferably made of silicon with a (100) orientation. A first mask pattern for defining the printing fluid reservoirs is photolithographically formed on upper wafer 100. The upper wafer 100 is then anisotropically wet etched to define the printing fluid reservoirs 40, as shown in FIG. 5A after removal of the first mask pattern.

A second mask pattern 210 for defining the printing fluid dispensing channels of the printing tips is photolithographically formed on lower wafer 200. The lower wafer 200 is then dry etched to partially define the printing fluid dispensing channels 63 of the printing tips, as shown in FIG. 5B.

As shown in FIG. 5C, a third mask pattern 120 for defining the flexible tethers and completing the fluid dispensing channels 63 is photolithographically formed on the bottom surfaces of the printing fluid reservoirs upper wafer 100. In addition, a fourth mask pattern 220 for defining the printing tips is photolithographically formed on the lower wafer 200 after removal of the second mask pattern 210.

The lower wafer 200 may then be dry etched to complete the printing tips 60, as shown in FIG. 5D after removal of the fourth mask pattern 220.

The structure of the microcontact printhead device 10 may be completed by dry etching the upper wafer 100 to define the flexible tethers 70 and complete the fluid dispensing channels 63, as shown in FIG. 5E after removal of the third mask pattern 120.

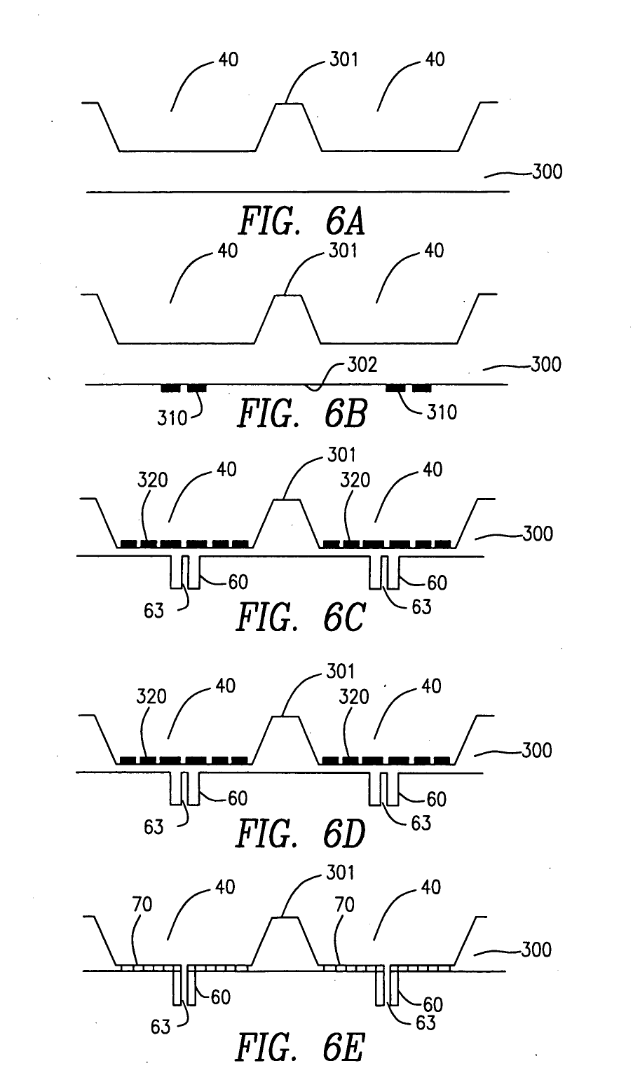

FIGS. 6A-6E collectively show another exemplary embodiment of the fabrication method of the present invention. In this embodiment of the method, the microcontact printhead device is fabricated from a single wafer 300 (preferably silicon with a (100) orientation). As shown in FIG. 6A, a first mask pattern (not shown) for defining the printing fluid reservoirs is photolithographically formed on an upper surface 301 of the wafer 300. The upper surface 301 of the wafer 300 is then anisotropically wet etched to define the printing fluid reservoirs 40 (FIG. 6B).

A second mask pattern 310 for defining the printing tips and a portion of the printing fluid dispensing channels is photolithographically formed on a lower surface 302 of the wafer 300 as shown in FIG. 6B.

The lower surface 302 of the wafer 300 is then dry etched to define the printing tips 60 and a portion of the fluid dispensing channels 63, as shown in FIG. 6C.

A third mask pattern 320 for defining the flexible tethers and completing the fluid dispensing channels 63 is photolithographically formed on the bottom surfaces of the printing fluid reservoirs 40 as shown in FIG. 6D.

The structure of the microcontact printhead device 10 may be completed by dry etching the upper surface 301 of the wafer 300 to define the flexible tethers 70 and complete the fluid dispensing channels 63, as shown in FIG. 6E after removal of the third mask pattern 320.

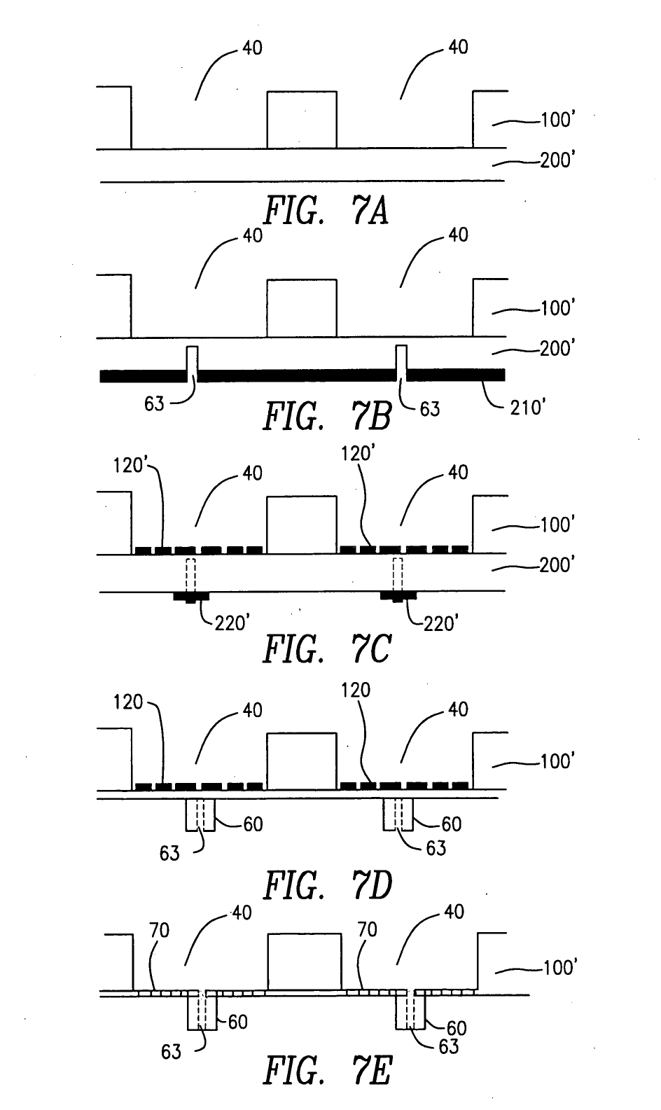

FIGS. 7A-7E collectively show a further exemplary embodiment of the microcontact printhead device fabrication method of the present invention. The method commences in FIG. 7A by bonding a glass wafer 100′, such as PYREX to a silicon wafer 200′, preferably with a (100) orientation using a conventional bonding techniques such as anodic bonding. Prior to bonding, the sides of the printing fluid reservoirs 40 are formed in the glass wafer 100′ using a conventional hole forming method such as ultrasonic drilling or laser cutting.

A first mask pattern 210′ for defining the printing fluid dispensing channels of the printing tips is photolithographically formed on the bottom surface of the silicon wafer 200′. The bottom surface of the silicon wafer 200′ is then dry etched to define the printing fluid dispensing channels 63 of the printing tips, as shown in FIG. 7B.

As shown in FIG. 7C, a second mask pattern 120′ for defining the flexible tethers is photolithographically formed on the top surface of the silicon wafer 200′. In addition, a third mask pattern 220′ for defining the printing tips is photolithographically formed on the bottom surface of the silicon wafer 200′ after removal of the first mask pattern 210′.

The bottom surface of the silicon wafer 200′ may then be dry etched to complete the printing tips 60, as shown in FIG. 7D after removal of the third mask pattern 220.

The structure of the microcontact printhead device 10 may be completed by dry etching the upper surface of the silicon wafer 200′ to define the flexible tethers 70, as shown in FIG. 7E after removal of the second mask pattern 120′.

FIGS. 9A-9E collectively show another exemplary embodiment of the fabrication method of the present invention. In this embodiment of the method, the microcontact printhead device is again fabricated from a single wafer 400 (preferably silicon with a (100) orientation). As shown in FIG. 9A, a first mask pattern 410 for defining the fluid dispensing channels has been photolithographically formed on an upper surface 401 of the wafer 400 and the upper surface 401 of the wafer 400′ has been dry etched to define tapered or frustoconically-shaped fluid dispensing channels 63′ (only one shown). As discussed earlier, tapering the fluid dispensing channels increases the capillary forces which draw the printing fluid into the fluid dispensing channels 63′.

A second mask pattern 415 for defining the printing tips and a portion of the printing fluid dispensing channels has been photolithographically formed on a lower surface 402 of the wafer 400 as shown in FIG. 9B. (A protective mask layer 416 has also been formed on the upper surface 401 of the wafer 400 to protect this surface during subsequent processing.)

The lower surface 402 of the wafer 400 is then wet etched to define the printing tip 60′ as shown in FIG. 9C. As can be seen, the outer surface of the printing tip 60′ is tapered or frustoconically-shaped similar to the fluid dispensing channel 63′ extending therethrough.

As shown in FIG. 9D, a third mask pattern 420 for defining the flexible tethers is formed on the top surface 401 of the wafer 400 (after removal of the protective mask layer 416 shown in FIG. 9B).

The structure of this embodiment of the microcontact printhead device 10′ may be completed by dry etching the upper surface 401 of the wafer 400 to define the flexible tethers 70, as shown in FIG. 9E after removal of the third mask pattern 420. Note that this embodiment of the microcontact printhead device 10′ does not include a defined printing fluid reservoir. It should be understood, however, that this embodiment of the microcontact printhead device may be modified to include the fluid reservoir structure.

A small sample of printing fluid may still be contained on top of the tethers 70 of the microcontact printhead device 10′ of FIG. 9E for printing. To prohibit lateral diffusion of the printing fluid samples in this embodiment, the nonwettable coating or chemical surface treatment described earlier may be applied to the upper surface 401 of the frame of the microcontact printhead device 10′ in the areas located between adjacent printing elements.

In the above described embodiments of the method, anisotropic wet etching may be accomplished, for example, with aqueous KOH at about 80° C. or ethylenediamine, and the dry etching may be accomplish, for example, with DRIE.

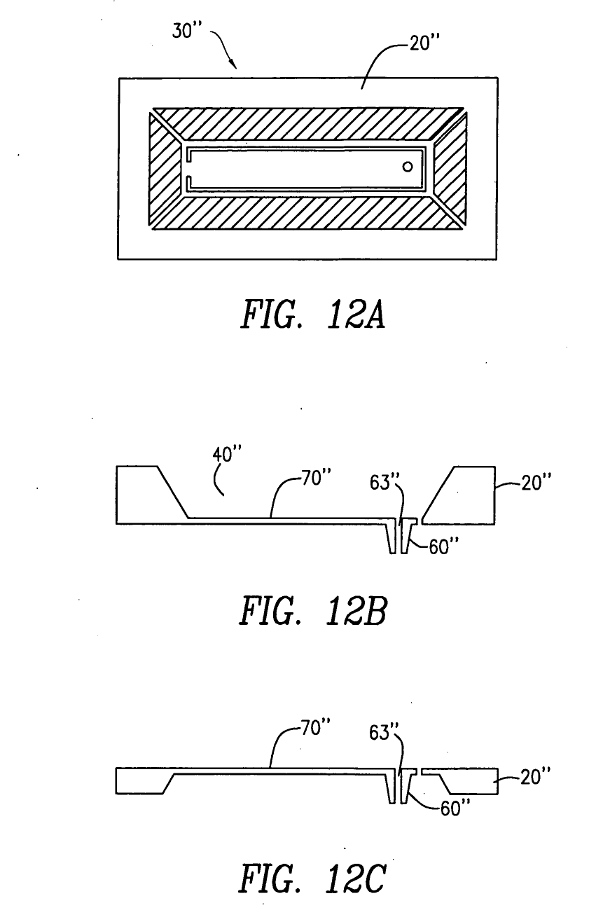

FIG. 11 shows an additional exemplary embodiment of the microcontact printhead device of the present invention, denoted by reference numeral 10″. The microcontact printhead device 10″ of this embodiment comprises a 2×4 array of the printing elements 30″. As shown in FIGS. 12A-12C, the printing elements 30″ of the microcontact printhead device 10″ are similar to the printing elements described earlier except that the printing tip 60″ may be attached to frame 20″ by one cantilever-type, flexible support member or tether 70″. Also, the printing elements 30″ may include a printing fluid reservoir 40″ as shown in FIG. 12B or omit the reservoir as shown in FIG. 12C.

The micromachined microcontact printhead device of the present invention addresses the deficiencies of conventional steel-based pins. The DRIE process produces cuts approximately 100× more precise and smooth than the techniques used to fabricate conventional steel-based machine shop pins. In addition, the DRIE process allows hundreds of printing tips to be fabricated in parallel, thus, pin-to-pin variation is essentially eliminated as compared to the steel pins. The higher micromachining precision also results in far more uniform printing tip end surface, which yields more consistently shaped spots and is capable of producing a printing tip end surface having a printing surface area of between about 5×10⁷ and 10⁻⁶ square micrometers. Further, both the printing tip density in the microcontact printhead device of the present invention and the size of the printing tips can be easily miniaturized. Approximately 20 μm diameter printing tips on 50-125 μm centers or less may be achieved using the fabrication method of the present invention. Accordingly a microcontact printhead device having a printing tip density between about 2 and 10¹² printing tips per square centimeter may be achieved. Because of their construction, it is not possible to pack the conventional steel pins closer than the 4.5 mm spacing of the 384 format. Printing tips on 50 μm centers are approximately 8×10³ denser than the densities of steel pins in conventional holders. The printing fluid reservoirs 30 of the microcontact printhead device 10 can be easily micromachined to hold just the amount of fluid needed for a printing experiment to minimize waste of valuable DNA samples. Since the printing tips in the preferred embodiment are made of silicon, a thin silicon dioxide (SiO₂) film typically coats the surfaces of the printing tips. The wetting properties, chemical compatibilities and derivatization chemistry of SiO₂ are well known as compared to the Cr₂O₃ surface of conventional stainless steel pins. Moreover, silicon is harder and much more elastic than stainless steel and will therefore wear much more slowly. The microcontact printhead device is also much less costly to manufacture than conventional steel pin microcontact printing devices.

A further aspect of the present invention is a method of printing a microarray using the microcontact printhead device of the present invention. In a first exemplary embodiment of the printing method, a different solution of a sample of a DNA oligonucleotide, for example DNA in 3×SSC buffer, is dispensed into each printing element fluid printing reservoir of the microcontact printhead device using an active fluid transfer device, such as a manual or automated pipetting system, e.g., liquid handling robot or pipette. A substrate is prepared for printing by coating a flat glass microscope slide with a reagent to immobilize the DNA. The reagent may be polylysine or other protonated surface amino group. The microcontact printhead device is quickly touched to the substrate surface with a force sufficient to cause each printing tip to deposit a small quantity, including without limitation, 10⁻¹⁰ picoliters to 100 nanoliters, of the DNA printing fluid onto the substrate. The substrate with the DNA microarray of deposited spots may then be used for experiments, such as gene expression monitoring by subjecting the microarray to hybridization reactions.

In a second exemplary embodiment of the printing method, a droplet array is prepared on a surface using a solution of a sample of a DNA oligonucleotide, for example DNA in 3×SSC buffer, and the atmosphere above the samples is controlled such that the samples do not evaporate. The droplet array may be prepared using, for example, an automated liquid dispenser which places the droplets onto a patterned hydrophobic surface. The hydrophobic surface precludes any lateral movement of the droplet. The microcontact printhead device of the present invention is loaded by dipping each printing tip into corresponding droplets of the droplet array (instead of loading the printing fluid directly into the printing elements as in the previous embodiment). A substrate is prepared for printing by coating a flat glass microscope slide with a reagent to immobilize the DNA. The reagent may be polylysine or other protonated surface amino group. The microcontact printhead device is quickly touched to the substrate surface with a force sufficient to cause each printing tip to deposit a small quantity, including without limitation, 10⁻¹⁰ picoliters to 10 nanoliters, of the DNA printing fluid onto the substrate. The substrate with the DNA microarray of deposited spots may then be used for experiments, such as gene expression monitoring by subjecting the microarray to hybridization reactions.

The micromachined microcontact printhead device of the present invention addresses many of the shortcomings and needs of conventional microcontact printing devices. It is clear that users of microcontact printing technologies, and the DNA microarray fabrication process itself, can benefit from the precision, rapid prototyping and economy of scale of the present invention. In addition, the microcontact printhead device may be readily adapted to existing printing hardware.

While the foregoing invention has been described with reference to the above, various modifications and changes can be made without departing from the spirit of the invention. Accordingly, all such modifications and changes are considered to be within the scope of the appended claims.

What is claimed is:

1. A microcontact printhead device comprising:
a frame; and
an array of at least two printing elements formed in the frame.

2. The microcontact printhead device according to claim 1, wherein the at least two printing elements are unitary with the frame.

3. The microcontact printhead device according to claim 1, wherein the frame is formed from at least one substrate.

4. The microcontact printhead device according to claim 3, wherein the at least one substrate is composed of a material selected from the group consisting of silicon, silicon carbide, silicon oxides, silicon nitride, germanium, germanium-silicon alloys, polymers, ceramics, and non-ferric alloys.

5. The microcontact printhead device according to claim 1, wherein each of the two printing elements includes a printing tip.

6. The microcontact printhead device according to claim 5, wherein each of the two printing elements further includes a printing fluid reservoir associated with the printing tip.

7. The microcontact printhead device according to claim 6, wherein each of the two printing elements further includes at least one support member that attaches the printing tip to the frame

8. The microcontact printhead device according to claim 7, wherein the at least one flexible support member is flexible so as to spring bias the printing tip in a direction perpendicular to a plane of the frame during printing.

9. The microcontact printhead device according to claim 8, wherein the spring bias controls printing pressure.

10. The microcontact printhead device according to claim 7, wherein the at least one support member forms a bottom of the reservoir.

11. The microcontact printhead device according to claim 7, wherein the at least one support member has a spiral shape.

12. The microcontact printhead device according to claim 7, wherein each of the two printing elements includes a fluid dispensing channel in communication with the printing fluid reservoir.

13. The microcontact printhead device according to claim 1, wherein the two printing elements each includes a printing fluid reservoir.

14. The microcontact printhead device according to claim 5, wherein each of the two printing elements includes at least one support member that attaches the printing tip to the frame.

15. The microcontact printhead device according to claim 14, wherein the at least one support member is flexible so as to spring bias the printing tip in a direction perpendicular to a plane of the frame.

16. The microcontact printhead device according to claim 15, wherein the spring bias controls printing pressure.

17. The microcontact printhead device according to claim 14, wherein the at least one support member has a spiral shape.

18. The microcontact printhead device according to claim 5, wherein each of the two printing elements includes a fluid dispensing channel.

19. A microcontact printhead device comprising:
a frame; and
an array of printing elements formed in the frame, each of the printing elements in the array including a printing tip.

20. The microcontact printhead device according to claim 19, wherein the printing elements are unitary with the frame.

21. The microcontact printhead device according to claim 19, wherein the array of printing elements has a printing tip density between about 2 and 100 printing tips per square centimeter.

22. The microcontact printhead device according to claim 19, wherein the array of printing elements has a printing tip density between about 100 and 1000 printing tips per square centimeter.

23. The microcontact printhead device according to claim 19, wherein the array of printing elements has a printing tip density between about 10³ and 10⁵ printing tips per square centimeter.

24. The microcontact printhead device according to claim 19, wherein the array of printing elements has a printing tip density between about 10⁵ and 10⁷ printing tips per square centimeter.

25. The microcontact printhead device according to claim 19, wherein the array of printing elements has a printing tip density between about 10⁷ and 10⁹ printing tips per square centimeter.

26. The microcontact printhead device according to claim 19, wherein the array of printing elements has a printing tip density between about 10⁹ and 10¹⁴ printing tips per square centimeter.

27. The microcontact printhead device according to claim 19, wherein each of the printing tips has a printing surface area of between about 5×10⁷ and 10³ square micrometers.

28. The microcontact printhead device according to claim 19, wherein each of the printing tips has a printing surface area of between about 10³ and 10² square micrometers.

29. The microcontact printhead device according to claim 19, wherein each of the printing tips has a printing surface area of between about 10² and 10 square micrometers.

30. The microcontact printhead device according to claim 19, wherein each of the printing tips has a printing surface area of between about 10 and 1 square micrometers.

31. The microcontact printhead device according to claim 19, wherein each of the printing tips has a printing surface area of between about 1 and 10⁻² square micrometers.

32. The microcontact printhead device according to claim 19, wherein each of the printing tips has a printing surface area of between about 10⁻² and 10⁻⁴ square micrometers.

33. The microcontact printhead device according to claim 19, wherein each of the printing tips has a printing surface area of between about 10⁻⁴ and 10⁻⁶ square micrometers.

34. The microcontact printhead device of claim 1, wherein the at least two printing elements each print a fluid.

35. The microcontact printhead device of claim 34, wherein the fluid is a solution of a biological material selected from the group consisting of DNA, RNA and protein molecules.

36. The microcontact printhead device of claim 35, wherein the fluid is an organic material selected from the group consisting of an organic small molecule, an organic polymer, a solution of an organic polymer, a dye, an ink, and an adhesive.

37. The microcontact printhead device of claim 34, wherein the fluid is an inorganic material selected from the group consisting of a molten metal, a solder, a glass, and a ceramic oxide.

38. The microcontact printhead device of claim 1, wherein the at least two printing elements are each capable of printing a different fluid.

39. A method of fabricating a microcontact printhead device, the method comprising:
forming an array of at least two printing fluid reservoirs in a first surface of at least one substrate; and
forming an array of printing tips in a second surface of the at least one substrate, the array of fluid dispensing channels communicating with the array of the at least two printing fluid reservoirs.

40. The method according to claim 39, wherein the array of at least two printing fluid reservoirs and the array of printing tips are formed by micromachining.

41. The method according to claim 39, wherein the array of at least two printing fluid reservoirs is formed by wet etching.

42. The method according to claim 41, wherein the array of printing tips is formed by dry etching.

43. The method according to claim 39, wherein the array of printing tips is formed by dry etching.

44. The method according to claim 39, wherein the at least one substrate is composed of a material selected from the group consisting of silicon, silicon carbide, silicon oxides, silicon nitride, germanium, germanium-silicon alloys, polymers, ceramics, and non-ferric alloys.

45. A method of fabricating a microcontact printhead device, the method comprising:
forming an array of at least two printing fluid reservoirs in a first surface of at least one substrate;
forming an array of printing tips in a second surface of the at least one substrate, the array of fluid dispensing channels communicating with the array of the at least two printing fluid reservoirs; and
forming at least one support member at a bottom of each of the at least two reservoirs.

46. The method according to claim 45, wherein the array of at least two printing fluid reservoirs, the array of printing tips, and the at least one support members are formed by micromachining.

47. The method according to claim 45, wherein the array of at least two printing fluid reservoirs is formed by wet etching.

48. The method according to claim 47, wherein the array of printing tips is formed by dry etching.

49. The method according to claim 48, wherein the at least one support members are formed by dry etching.

50. The method according to claim 45, wherein the array of printing tips is formed by dry etching.

51. The method according to claim 45, wherein the at least one support members are formed by dry etching.

52. The method according to claim 45, wherein the at least one substrate is composed of a material selected from the group consisting of silicon, silicon carbide, silicon oxides, silicon nitride, germanium, germanium-silicon alloys, polymers, ceramics, and non-ferric alloys.

53. The microcontact printhead device according to claim 7, wherein the at least one support member comprise a thin diaphragm.

54. The microcontact printhead device according to claim 7, wherein the at least one support member has a width and a length, the width varying along the length to generate a capillary force that draws a printing fluid contained in the corresponding printing fluid reservoir to the printing tip during printing.

55. The microcontact printhead device according to claim 7, wherein the at least one support member includes lateral interdigital texturing along a portion of a length of the at least one support member, the lateral interdigital texturing generating a capillary force that draws a printing fluid contained in the corresponding printing fluid reservoir to the printing tip during printing.

56. The microcontact printhead device according to claim 12, wherein at least one of the fluid dispensing channels is tapered to generate a capillary force that draws a printing fluid contained in the corresponding printing fluid reservoir into the fluid dispensing channel during printing.

57. The method according to claim 39, wherein the at least one substrate comprises a glass substrate and a silicon.

58. The method according to claim 39, wherein the at least one substrate comprises two silicon substrates.

59. The method according to claim 45, wherein the at least one substrate comprises a glass substrate and a silicon substrate.

60. The method according to claim 45, wherein the at least one substrate comprises two silicon substrates.

61. A method of printing an array of spots, the method comprising;
providing a microcontact printhead device having a frame and an array of at least two printing elements formed in the frame, the at least two printing elements including a printing tip and a printing fluid reservoir;
filling each of the printing fluid reservoirs with one of at least two sample solutions; and
touching a surface with the printing tips to deposit quantities of the sample solutions onto the surface, the quantities of the sample solutions forming the array of spots.

62. The method according to claim 61, wherein the quantity of each of the sample solutions comprises 10⁻¹⁰ picoliters to 10 nanoliters.

63. The method according to claim 61, wherein the filling is performed with an active fluid transfer device.

64. The method according to claim 63, wherein the active fluid transfer device comprises one of a manual pipetting system and an automated pipetting system.

65. The method according to claim 61, wherein the filling is performed by:
placing a droplets of the at least two sample solutions onto a hydrophobic surface; and
dipping each of the printing tips into corresponding droplets.

66. The method according to claim 61, where the surface comprises a flat glass microscope slide.
